(19) United States
(12) Patent Application Publication
(10) Pub. No.: US 2026/0274051 A1
(43) Pub. Date: Sep. 17, 2026

(54) DEVELOPMENT IN A CURTAIN ASSEMBLY

(71) Applicant: AL-KOR MAKINA KALIP SANAYI VE TICARET A.S., Arnavutkoy, Istanbul (TR)

(72) Inventors: Erol DIVANYAN, Arnavutkoy, Istanbul (TR); Yasin CAGLAYAN, Arnavutkoy, Istanbul (TR); Sercan MARAZYAN, Arnavutkoy, Istanbul (TR)

(21) Appl. No.: 19/131,817

(22) PCT Filed: Jul. 7, 2023
(86) PCT No.: PCT/TR2023/050663

§ 371 Date: May 21, 2025

(30) Foreign Application Priority Data
Dec. 30, 2022 (TR) 2022/021528

(51) Int. Cl. B60J 1/20

(52) U.S. Cl. CPC B60J 1/2033

(57) ABSTRACT

A curtain assembly includes a curtain fabric, an upper assembly mounted on the curtain fabric, a lower assembly mounted below the curtain fabric, and at least one body located in the lower assembly. The body includes a tube made of aluminum, a spring activator connected to the tube, a spring connected to the spring activator, at least one ball bearing connected to the tube, an inner lath and an outer lath, made of plastic, forming the upper assembly.

### SUBJECT OF THE INVENTION AND TECHNICAL FIELD

The invention relates particularly to a curtain assembly used in the automotive industry. The present invention relates to the developments made in a curtain assembly which is preferably used in vehicles in the automotive sector, can absorb the sounds that may occur when mounted on the vehicle, has a compact and simple mechanism, and allows the curtain to retract itself when released.

### State of the Art

In the state of the art, the curtain mechanisms used in vehicles and enabling the curtain to retract itself are known. The number of parts in the mechanisms for the curtain to retract itself in said curtain assemblies is quite high and therefore the assembly is difficult and the production costs are high. In addition, in these mechanisms, the costs are even higher when the rotational movement required for the curtain to retract itself is provided by the drive elements. Therefore, it has become a necessity to present the solutions with low number of parts, easy to assemble and low production cost, which will enable the curtain to retract itself in vehicles.

It is known that the number of parts in the existing mechanisms for the curtain's movement to retract itself in the curtain assemblies available in the state of the art is quite high and complex. It is known that the excess number of the parts both increases the production costs and makes it difficult to mount the curtain assembly on the vehicle.

It is known that the costs increase even more when a drive element is used to provide the rotational movement required for the curtain product to retract itself in the curtain assemblies available in the state of the art.

It has become a necessity to lighten by mass the curtain assemblies used in vehicles due to the large number of parts used in the curtain assemblies in the state of the art and the weight created by the mass of these extra parts.

It is known that the problems such as losing a lot of time while assembling the curtain assembly due to the multi-piece and heavy structure of the curtain assemblies in the state of the art are known.

In the state of the art, the high specific gravity of the material to be assembled in the curtain assemblies and the assembly problems increase the production cost of the materials.

In the state of the art, the vinyl welding of the aluminum rod material, on which the handle part is mounted in curtain assemblies, with the curtain fabric causes an increase in the production processes.

In the state of the art, the use of the metal rods in the upper mechanism, in which the handle part of the material to be mounted in the curtain assemblies, causes the curtain assembly to become heavier in mass.

In the state of the art, the problems of not being able to move the curtain in any direction other than the up and down movement are encountered during the assembly of the curtain assemblies to the vehicle.

In the state of the art, there is an application No. 2017/07855 of Al-Kor Makina Kalip Sanayi ve Ticaret A.Ş. about the curtain assembly used in the vehicles. However, this application includes an assembly that uses heavier parts by mass and has a thicker structure. Our new application uses an ultrasonic welding method for the production process improvement and the developments in the handle part, drive element, rubber wedge, inner and outer plastic laths, axial (movement bearing) ball bearing by using the materials absorbing the sounds and vibrations in our prior patent No. 2017/07855.

The patent application no. U.S. 2016/0083998 discloses a cylindrical tube with an inner surface defining an axial hole, a shaft comprising an external threaded section defining a spiral groove, at least one follower element operatively associated with the cylindrical tube and configured such that the shaft is located within the axial bore of the cylindrical tube for axial movement in the cylindrical tube at one end of the cylindrical tube, and a cylindrical canopy assembly in which at least one follower element is configured to be driven into the spiral groove to convert the axial rotation of the cylindrical tube into the axial motion in the support tube. The follower element is connected to one end of the cylindrical tube from a close position to the spiral groove. The initial axial position of the cylindrical tube in relation to the support tube can be adjusted by manually rotating the shaft without the rotation of the support tube.

The patent application no. U.S.2002069980A1 discloses a spring-operated roller blind structure with the adjustable width that maintains the proper orthogonal following at all available widths within the width adjustment range of the sunshade.

The patent application no. U.S.2009283224A1 discloses a development in a mechanism in which it is possible to adjust a degree of light shading according to the overlapping state of a light-transmitting part and another light-transmitting part, or a light-transmitting part and an opaque part by moving one of the two blind raw materials horizontally, and the up and down height can be adjusted freely.

As can be seen in the patents mentioned above, in the state of the art, there are various patent applications related to the curtain assembly. However, the applications do not disclose the curtain assemblies developed to absorb the sound and to lighten the whole material.

### Technical Problems to Be Solved by the Invention

It is the object to improve and lighten the section and structure of the aluminum body by using especially the inner plastic and outer plastic lath parts, instead of metal rods, despite the increase in dimensions in the curtain assembly according to the invention, and to reduce the production costs, as well as to provide ease of use in the production and assembly stages by increasing the efficiency of the material.

It is the object to reduce the number of parts used in the curtain assemblies in the state of the art and to make the curtain assemblies used in the vehicles lighter in mass.

It is object to save time while assembling the curtain assembly due to the lighter structure with fewer parts of the curtain assembly in the state of the art.

It is the object to provide a lower specific gravity of the material to be assembled in the curtain assemblies in the state of the art and to reduce the production cost of the materials due to the assembly problems.

It is the object to minimize the long production processes by using the plastic welding instead of vinyl welding in the aluminum rod part in which the handle part will be mounted in the curtain assemblies in the state of the art.

In the state of the art, instead of using metal rods in the upper mechanism in which the handle part of the material to be mounted in curtain assemblies is used, the plastic laths are used to make the curtain assembly lighter in mass.

In the state of the art, by adding a ball bearing part to the curtain assembly, the curtain assembly is not affected by the errors in the vehicle door, allowing the curtain assembly to move horizontally to the right or left, apart from the up and down movement. Thus, it is possible for the curtain assembly to easily enter the channel in the assembly area.

Another advantage of the curtain assembly according to the invention is that the curtain body can be easily changed according to demand and need.

In order to better understand the curtain assembly according to the invention, the figures will be referred.

### DESCRIPTION OF THE FIGURES

FIG. 1 shows the perspective frontal view of the curtain assembly according to the invention.

FIG. 2 shows the perspective exploded view of the lower assembly of the curtain assembly according to the invention.

FIG. 3 shows the cross-sectional view of the spring mechanism in the curtain assembly according to the invention.

FIG. 4 shows the projection view of the tube and ball bearing elements in the curtain assembly according to the invention.

FIG. 5 shows the right perspective view of the ball bearing element in the curtain assembly according to the invention.

FIG. 6 shows the frontal projection view of the ball bearing element in the curtain assembly according to the invention.

FIG. 7 shows the perspective view of the inner cover element in the curtain assembly according to the invention.

FIG. 8 shows the perspective view of the front cover element in the curtain assembly according to the invention.

FIG. 9 shows the perspective view of the rear cover element in the curtain assembly according to the invention.

FIG. 10 shows the front view of the spring activator element in the curtain assembly according to the invention.

FIG. 11 shows the frontal view of the spring activator element in the curtain assembly according to the invention.

FIG. 12 shows the perspective view of the spring activator lock element in the curtain assembly according to the invention.

FIG. 13 shows the frontal projection view of the spring element in the curtain assembly according to the invention.

FIG. 14 shows the frontal perspective view of the handle element in the curtain assembly according to the invention.

FIG. 15 shows the top perspective view of the handle element in the curtain assembly according to the invention.

FIG. 16 shows the perspective view of the wedge part in the curtain assembly according to the invention.

FIG. 17 shows the perspective view of the body element in the curtain assembly according to the invention.

FIG. 18 shows the frontal projection view of the body element in the curtain assembly according to the invention.

FIG. 19 shows the perspective exploded view of the elements of the upper assembly of the curtain assembly according to the invention.

FIG. 20 shows the perspective view in which the elements of the upper assembly of the curtain assembly according to the invention are together.

FIG. 21 shows the perspective view of the upper assembly, lower assembly and curtain of the old version of the curtain assembly according to the invention.

FIG. 22 shows the perspective view of the upper assembly and curtain of the old version of the curtain assembly according to the invention.

FIG. 23 shows the perspective view of the body element of the old version of the curtain assembly according to the invention.

FIG. 24 shows the projection view of the body element of the old version of the curtain assembly according to the invention.

FIG. 25 shows the perspective view of the handle element of the old version of the curtain assembly according to the invention.

FIG. 26 shows the perspective view of the spring element of the curtain assembly according to the invention.

### REFERENCE NUMBERS OF PARTS AND SECTIONS THAT HELP EXPLAIN THE INVENTION

1—Body
   1a—Felt slot
2—Felt
3—Tube
4—Ball bearing
5—Rear cover
6—Spring activator lock
7—Spring activator
8—Spring
9—Inner cover
10—Front cover
11—Outer lath
   11a—Outer lath wedge slot
12—Inner lath
   12a—Inner lath wedge slot
13—Handle
14—Handle pin
15—Wedge
16—Screw
17—Lower assembly
18—Upper assembly
19—Curtain fabric
20—Old lower assembly
   20a—Old assembly body
21—Old upper assembly
   21a—Old upper assembly tube
   21b—Old upper assembly handle
   21c—Old assembly curtain fabric

### DETAILED DESCRIPTION OF THE INVENTION

The development in a curtain assembly used in the vehicles according to the invention is a curtain assembly that retracts itself, has fewer parts and can be easily assembled, as well as a curtain assembly that will allow the increased efficiency by creating a longer and lighter sunshade system. The object of said curtain assembly is to provide a more efficient and lighter curtain assembly with fewer parts by reducing the production cost of the curtain assemblies obtained by using a handle part in curtain assemblies, made of a more flexible material with a lower degree of hardness, a wedge and felt made of rubber material that absorbs the vibration-induced sounds, and at least one, preferably two, ball bearing materials that allow the curtain to move left or right on its axis.

With the development made in a curtain assembly used in the vehicles according to the invention, instead of the metal rod in the existing curtain assembly, it is possible to lighten the old curtain assembly in mass by using at least two inner and outer interconnected laths.

With the development made in a curtain assembly used in the vehicles according to the invention, at least one, preferably two rubber wedges made of EPDM (Ethylene Propylene Diene Monomer) material capable of absorbing the unavoidable sounds caused by vibration in the existing curtain assembly, after the curtain is mounted on the vehicle, and dampening the sounds occurring during the contact of the upper assembly mechanism with the vehicle, and a special felt made of sound management film tape material for dampening the sounds during the contact of the lower assembly mechanism with the vehicle are used.

The long production processes will be avoided by using the ultrasonic welding, instead of vinyl welding used in the old system, on the aluminum bar to which the handle in the curtain assembly according to the invention will be mounted. The ultrasonic welding is a welding technique that allows two different plastic parts to be joined in a single body without the need to use chemical reagents or adhesives. This welding technique makes it possible to act on the plastic polymers at the molecular level. In addition, a more flexible soft material is preferred by changing the material of the handle in the old assembly, that is, by reducing the hardness degree from 83 Shore A to 45 Shore A (Shore A stands for hardness value), and it allows the user to experience a more ergonomic feeling during use (opening-closing).

With the development made in a curtain assembly used in the vehicles according to the invention, it is possible to move the curtain in the developed curtain assembly from left to right or from right to left, that is, in the spring axis, as well as the movement from top to bottom, with the addition of the ball bearing, while the curtain in the existing curtain assembly can only be moved from top to bottom or from bottom to top. In addition, the curtain assembly creates an assembly that can be attached and removed more easily and comfortably to the assembly area with the ball bearing parts added.

Said design can be a design as seen in the views for a better understanding of the subject, or it can be in different geometries and different sizes by preserving the technical elements. The views used in the invention are for illustrative purposes only and should not be binding.

A development in the curtain assembly according to the invention is designed to use in automobiles as well as in buses, trucks and other automotive group vehicles. Said design can also be integrated into the air and sea vehicles.

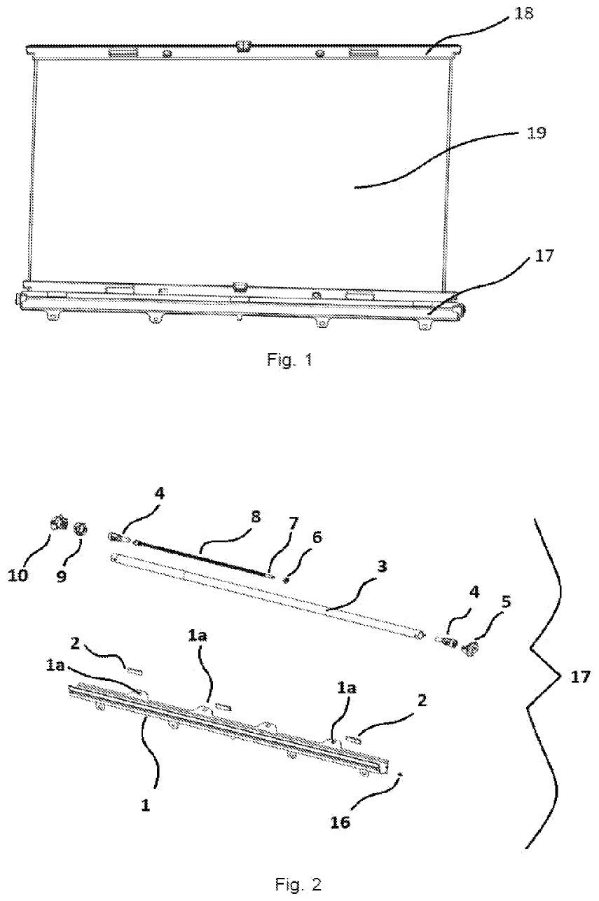

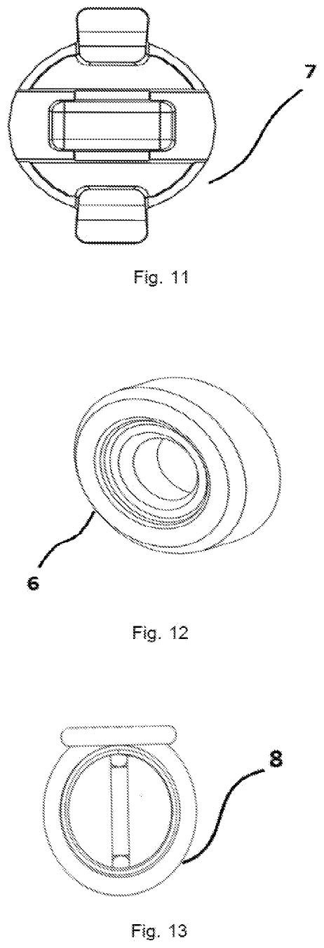

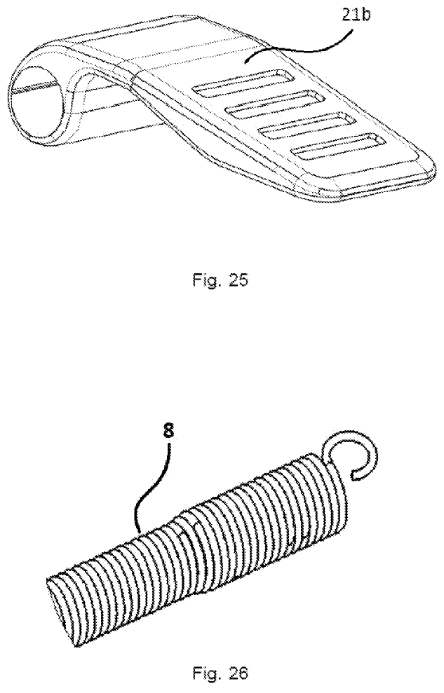

The elements contained in the projector according to the invention are generally seen from the different perspectives from FIG. 1 to FIG. 26.

As seen in the perspective view of FIG. 1, a curtain assembly according to the invention comprises generally a curtain fabric (19), an upper assembly (18) mounted on said curtain, a lower assembly (17) mounted below said curtain, and at least one body (1) located in said lower assembly (17), characterized in that said body (1) comprises a tube (3) made of aluminum, a spring activator (7) connected to said tube (3), a spring (8) connected to said spring activator (7), at least one ball bearing (4) connected to said tube (3), an inner lath (12) and outer lath (11), made of plastic, forming said upper assembly (18).

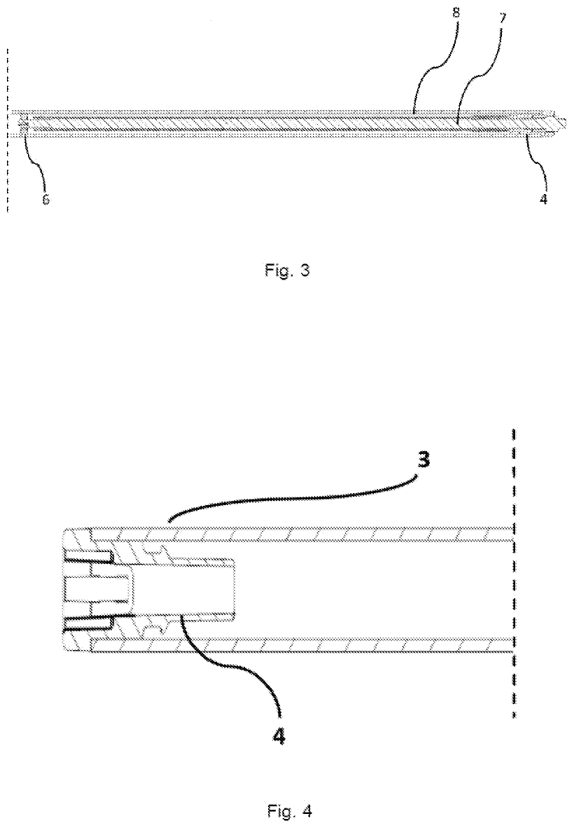

FIG. 1 comprises a lower assembly (17), an upper assembly (18) and a curtain fabric (19). FIG. 2 shows an exploded view of the lower assembly (17) of the curtain. As seen in the perspective view of FIG. 2, said lower assembly (17) comprises a body (1) made of aluminum, a tube (3), made of an aluminum, located in said body (1), a spring activator (7) connected to said tube (3), and a spring (8) connected to said spring activator (7). Said tube (3) is preferably made of aluminum for lightness and strength, but if desired, it can also be made of alloy and plastic material. In the body (1) forming said lower assembly (17), there is a sound-directed film tape absorbing the sounds, and a special felt (2) made of rubber. Said felt (2) is attached to the aluminum body (1) by folding. Said body (1) is connected with at least one screw (16). It is possible to open and close the curtain mechanism as a result of the integration of the above-described parts placed in said aluminum body (1) and in the lower assembly (17). The curtain system is opened and closed in that the curtain fabric (19) shown in FIG. 1 is wrapped around the tube (3) made of aluminum shown in FIG. 2, and the installed spring (8) shown in FIG. 3 is activated. The spring (8) shown in FIG. 3 is attached to the spring activator (7), while the spring activator lock (6) locks the assembly and keeps it in the installed position. Said spring activator (7) is connected to said spring (8) and said spring activator lock (6) and this structure will be referred to as spring mechanism. Said spring mechanism is placed inside the aluminum tube (3) and both ends, as seen in FIG. 2, of said tube (3) are connected to the ball bearing (4). The spring activator (7) is fixed by adding at least two ball bearings (4) to said spring mechanism. The fixing process with said ball bearing (4) is carried out after said spring (8) is attached to the spring activator (7). The elasticity coefficient of said spring (8) is important for the operation of the curtain mechanism. FIG. 3 includes a spring activator lock (6), a spring activator (7), a spring (8), and a slide cover (4).

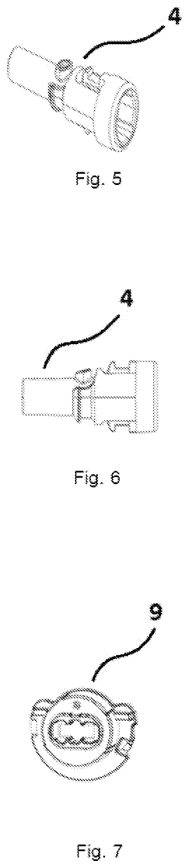

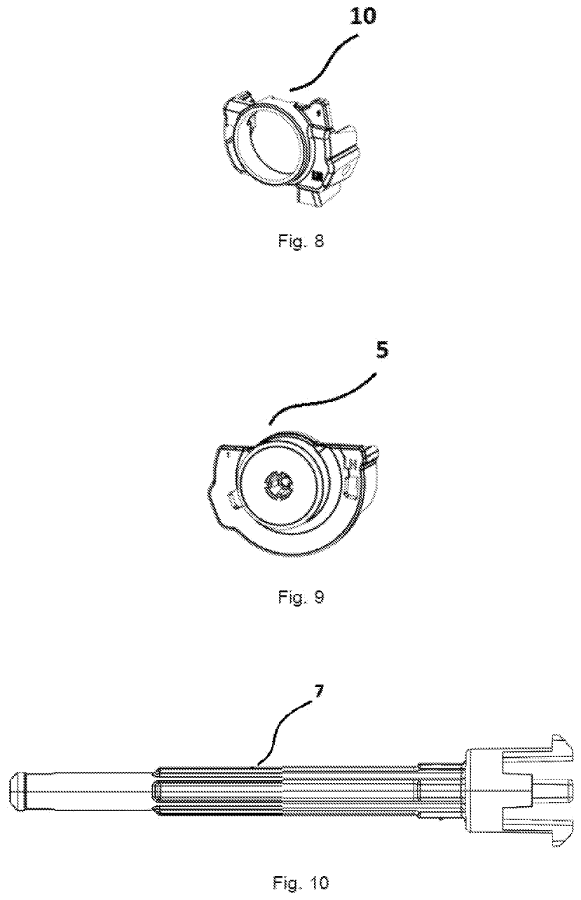

FIG. 4, FIG. 5 and FIG. 6 show the different views of the ball bearing (4). The notch at the end of the spring (8) seen in FIG. 26 is inserted into this part, thereby keeping the end of the spring (8) fixed. The movable tab in the ball bearing (4) mechanism ensures that the part is attached to the aluminum tube (3). The spring activator (7) in FIG. 10 and FIG. 11 is rotated around the same axis with the spring (8) and the spring (8) is activated. By means of the tabs on the spring activator (7), the inner cover (9) shown in FIG. 7 is installed. The rotation movement is given from the outside of the mechanism to said spring activator (7) by said inner cover (9). The front cover (10) in FIG. 8 is attached to the inner cover (8) from the side, in which the product mechanism is installed, and fixed to said body (1), made of aluminum, by means of the screw (16) shown in FIG. 2.

Inside the body (1) in FIG. 17 and FIG. 18, the rear cover (5) in FIG. 9 is fixed to the aluminum tube (3) shown in FIG. 2 and FIG. 4 by the screw (16), and the assembly phase of the lower assembly (17) is completed.

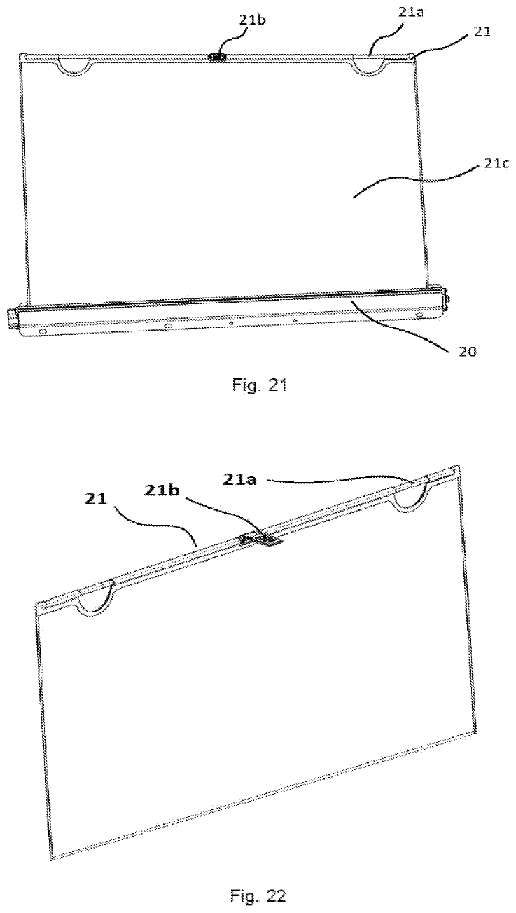

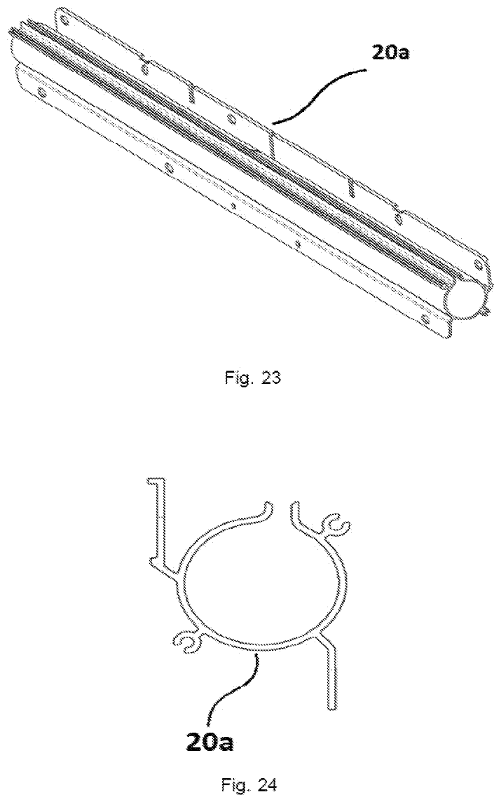

The developed body (1) and lower assembly (17) in the curtain assembly are shown in FIG. 2, the lower body (20) of the old curtain is shown in FIG. 21, and FIG. 23 and FIG. 24 show the body (20a) profile of the old assembly for the comparison purposes in order to more easily understand the development made in the old and new curtain assembly. The body (1) in FIG. 2 has been manufactured in a thinner section and in a simpler structure with fewer parts compared to the body of said old assembly (20a), thus making the curtain mechanism lighter despite being larger. In order to absorb the vibrations that occur during the montage of the lower assembly (17) shown in FIG. 2 to the vehicle, a sound-directed film tape and a special felt (2) made of rubber are used. In order to absorb the possible errors in the vehicle door in which said curtain assembly is attached, it is allowed to move the curtain on its own axis with said ball bearing (4).

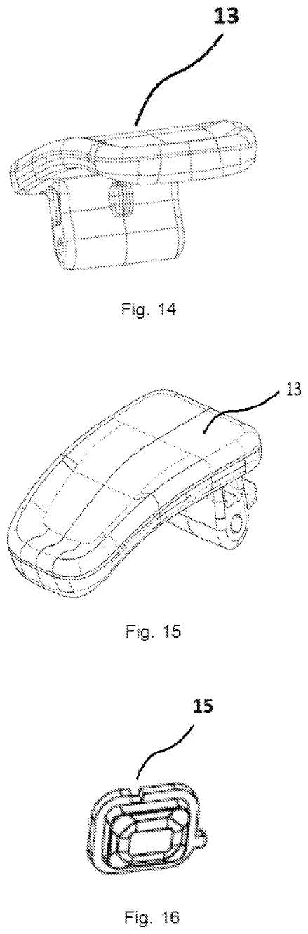

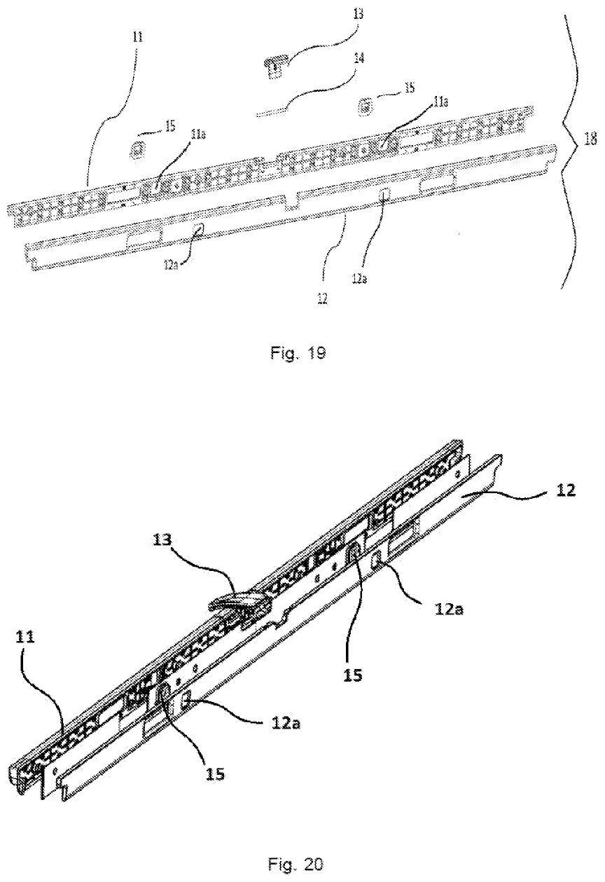

In the upper assembly (18) systems shown in FIG. 14 and FIG. 15, there is a handle (13) which provides the opening and closing movement of the curtain fabric (19). In FIG. 19 and FIG. 20, there are outer lath (11) and inner lath (12) which are made of plastic. Said outer lath (11) and inner lath (12) are joined by the ultrasonic welding. There is an inner lath wedge slot (12a) located in said inner lath (12) and an outer lath wedge slot (11a) located in said outer lath (11). Said handle (13) is mounted between the outer lath (11) and the inner lath (12). The newly developed handle (13) is shown in FIG. 13 and the old mechanism handle (21b) in the old curtain assembly is shown in FIG. 14. The newly developed handle (13) is manufactured in a softer and stronger structure than the old mechanism handle (21b). In addition to the reduced hardness value in the new curtain assembly handle (13), it also provides ease of assembly.

In order to ensure the ergonomic comfort of the users in said handle (13), a low hardness (shore) value is preferred. However, a more rigid structure was preferred in order to prevent the deformations that may occur during use.

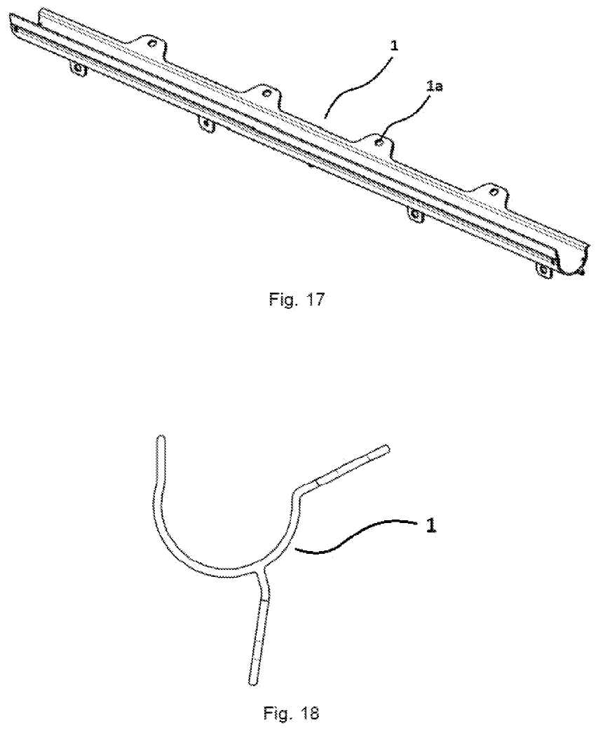

FIG. 16 shows a wedge (15) made of EPDM rubber material. Said upper assembly (18) dampens the sounds that occur during the contact of the mechanism with the vehicle. The wedge (15) made of EPDM rubber material, which is inserted into the window in said outer lath (11) and inner lath (12), absorbs sounds as well as is easy to assemble.

### INDUSTRIAL APPLICATION OF THE INVENTION

A development in the curtain assembly according to the invention is designed to use in automobiles as well as in buses, trucks and other automotive group vehicles. Said design can also be integrated into the air and sea vehicles.

1. A curtain assembly, comprising a curtain fabric, an upper assembly mounted on said curtain fabric, a lower assembly mounted below said curtain fabric, and at least one body located in said lower assembly, wherein said body comprises a tube made of aluminum, a spring activator connected to said tube, a spring connected to said spring activator, at least one ball bearing connected to said tube, an inner lath and outer lath, made of plastic, forming said upper assembly.

2. A curtain assembly according to claim 1, comprising an inner lath wedge slot located in said inner lath and an outer lath wedge slot located in said outer lath.

3. A curtain assembly according to claim 1, comprising a handle which allows the parts of said inner lath and outer lath to be easily mounted to each other by reducing the hardness degree from 83 to 45.

4. A curtain assembly according to claim 2, comprising a wedge, made of rubber, which is located in said outer lath wedge slot and said inner lath wedge slot.

5. A curtain assembly according to claim 1, wherein it allows the curtain mechanism of said ball bearing to move to the right and left sides, except for the up and down movement.

6. A curtain assembly according to claim 1, wherein said body comprises a felt slot.

7. A curtain assembly according to claim 6, comprising a sound-directed film tape capable of absorbing the vibrations and located in said felt slot, and a special felt made of rubber.

8. A curtain assembly according to claim 1, wherein the outer lath and the inner lath are joined by the ultrasonic welding.
